(19) United States
(12) Patent Application Publication
(10) Pub. No.: US 2016/0281396 A1
(43) Pub. Date: Sep. 29, 2016

(54) Vehicle Security System and Method of Manufacture

(71) Applicant: Steven C. Jokinen, Pepperell, MA (US)

(72) Inventor: Steven C. Jokinen, Pepperell, MA (US)

(21) Appl. No.: 15/081,829

(22) Filed: Mar. 25, 2016

Related U.S. Application Data
(60) Provisional application No. 62/139,130, filed on Mar. 27, 2015.

(51) Int. Cl. E05B 77/44; E05B 81/08; E05B 83/36; E05B 81/56; E05B 83/24; E05B 83/32; E05B 81/04; E05B 81/18

(52) U.S. Cl. CPC E05B 77/44; E05B 81/04; E05B 81/08; E05B 81/18; E05B 81/56; E05B 83/24; E05B 83/32; E05B 83/36

(57) ABSTRACT

The present application is directed to a vehicle security system which is capable of selectively locking and unlocking various compartments. In one embodiment, the vehicle security system which is capable of at least one user input device configured to generate one or more input signals. Further, the vehicle security system includes at least one lock control body positioned within a compartment of a vehicle. The lock control body is in communication with the user input device. The lock control body includes at least one lock shaft configured to be selectively extendable from and retracted to the housing of the lock control body in response to the input signal from the user input device. In addition, the vehicle security system includes at least one lock shaft receiver positioned on a door of the compartment proximate to the lock control body and configured to receive the lock shaft therein.

### CROSS-REFERENCE TO RELATED APPLICATIONS

The present application claims priority of U.S. Provisional Patent Application Ser. No. 62/139,130, entitled “Vehicle Security System and Method of Manufacture,” filed on Mar. 27, 2015, the contents of which are incorporated by reference in its entirety herein.

### BACKGROUND

Presently, vehicle theft is a continuing problem for society. In fact, a vehicle is stolen in the United States approximately every 26 seconds. The societal effects of vehicle theft are far reaching. A considerable amount of law enforcement's time is consumed investigating vehicle theft, which diverts law enforcement's efforts from investigating more serious crimes. Further, automobile insurance rates continue to increase in response to a number of factors, including the increasing costs of repairing or replacing stolen vehicles. In recent years, sport utility vehicles (hereinafter SUVs) have been targeted by vehicle thieves. More specifically, Jeep Wranglers™ (hereinafter Wranglers) have been particularly favored by vehicle thieves as evidenced by the fact that these vehicles commonly rank among the top ten (10) vehicles stolen each year.

The utilitarian capabilities of SUVs, and particularly Wrangler's and similar vehicles, are well known. These vehicles have been used to traverse areas thought to be impassable by motor vehicles. For example, these vehicles are commonly used in off-road settings. As a function of their intended use, the design of these vehicles is focused on mechanical reliability rather than theft prevention. For example, FIG. 1 shows a schematic of the security system of a Wrangler or SUV. As shown in FIG. 1, the vehicle 15 includes a body 17 having a passenger compartment 19 formed therein. Access to the passenger compartment 19 may be gained via at least one door 27 coupled to the body 17 in the body. Further, the body 17 further includes an engine compartment 21 configured to house the engine therein, and at a storage compartment or trunk 23. Often, the vehicle 15 includes a master control or computer system 25 configured to control various subsystems of the vehicle 15 including, for example, ignition systems, fuel injection systems, environmental control, security systems and the like. Typically, a user input device 29 such as a remote actuator may be used to activate actuate at least a portion of the master control system 25. For example, the user may actuate the user input device 29 to generate a user control signal 31 which is sent from the user control device 29 to the master control system 25 resulting in the security subsystem 33 of the vehicle activating or deactivating. During use, the security system 33, if present, may restrict or permit access to the vehicle by selectively locking/unlocking the doors 27. In addition, the security system 33 may prevent or restrict ignition of the vehicle's engine.

FIGS. 2-4 show a various views of a SUV, more specifically a Wrangler. As shown, the vehicle 1 includes a body 3 having one or more doors 5 coupled thereto. Further, the vehicle 3 includes a hood 7 which encloses the engine compartment housing the vehicle engine. The hood 7 is secured in place by the latch assembly 9. As shown in FIG. 2, the latch assembly 9 comprises a latch device 11 positioned on the body 3 and a latch feature 13 positioned on the hood 7. The latch device 11 positioned on the body 3 is configured to selectively engage and couple to the latch feature 13 positioned on the hood, thereby controllably securing the hood 7 to the body 3. In addition, the hood 7 may include at least one safety latch hook assembly 35 found on most vehicles. As shown, the safety latch hook assembly 35 is positioned on an interior portion of the hood 7 of the vehicle 1 and configured to selectively engage/disengage a latch passage 37 formed within a plate member 39 positioned within the engine compartment 21 (See FIG. 1).

While the vehicle and vehicle security system described in FIGS. 1-3 has proven useful in the past, a number of shortcomings have been identified. For example, the security system described above is largely incapable of restricting unwanted access to the vehicle's engine and engine compartment. More specifically, integration of the mechanical latch assembly 9 (See FIGS. 2 and 3) into the vehicle's security system 33 (See FIG. 1) has proven challenging and largely ineffective. Moreover, once a thief gains access to the engine compartment the vehicle's security system may be easily deactivated or otherwise circumvented thereby permitting the thief to easily steal the vehicle.

Thus, in light of the foregoing, there is an ongoing need for an improved vehicle security system capable of selectively restricting or permitting access to the engine compartment of a vehicle.

### SUMMARY

The present application is directed to a vehicle security system which is capable of selectively locking and unlocking various compartments. In one embodiment, the vehicle security system includes at least one user input device configured to generate one or more input signals. Further, the vehicle security system includes at least one lock control body positioned within a compartment of a vehicle. The lock control body is in communication with the user input device. The lock control body includes at least one lock shaft configured to be selectively extended from and retracted to the housing of the lock control body in response to the input signal from the user input device. In addition, the vehicle security system includes at least one lock shaft receiver positioned on a door of the compartment proximate to the lock control body and configured to receive the lock shaft therein.

In another embodiment, a vehicle security system is disclosed which includes at least one user input device configured to generate one or more input signals. The system further includes at least one lock control body positioned on the body of the vehicle within the engine compartment of the vehicle and in communication with the user input device. The lock control body includes at least one housing having at least one lock shaft in communication with at least one actuator. As such, the lock shaft is configured to be selectively extendable from and retractable to the housing in response to the input signal from the user input device. In addition, the vehicle security system includes at least one lock shaft receiver positioned on the hood of the vehicle enclosing the compartment proximate to the lock controller. The lock shaft receiver is configured to receive the lock shaft therein.

In another embodiment, the present application is directed to a vehicle security system and includes at least one user input device configured to generate one or more input signals. Further, the vehicle security system includes at least one auxiliary safety latch body coupled to a safety latch system positioned on a hood of a vehicle within the engine compartment of the vehicle. At least one lock control body is positioned within the engine compartment and is in communication with the user input device. The lock control body includes at least one housing having at least one lock shaft in communication with at least one actuator. The lock shaft is configured to be selectively extendable from housing and configured to engage the auxiliary safety latch body in response to the input signal from the user input device thereby preventing the hood from opening. In addition, the lock shaft is configured to be selectively retractable to the housing and configured to disengage the auxiliary safety latch body in response to the input signal from the user input device thereby permitting the hood to open.

Other features and advantages of the vehicle security system and methods of manufacture as described herein will become more apparent from a consideration of the following detailed description.

### BRIEF DESCRIPTION OF THE DRAWINGS

Various embodiments of the vehicle security system and methods of manufacture will be explained in more detail by way of the accompanying drawings, wherein:

FIG. 1 shows a schematic diagram of an exemplary embodiment of a prior art vehicle security system;

FIG. 2 shows an elevated perspective view of a sports utility vehicle having an exemplary prior art vehicle security system included therewith;

FIG. 3 shows an elevated perspective view of a hood latch hook assembly securing the hood of a vehicle in a closed position;

FIG. 4 shows a planar perspective view of a prior art safety latch assembly positioned within the engine compartment of a vehicle;

FIG. 5 shows a schematic diagram of an exemplary embodiment of a novel vehicle security system;

FIG. 6 shows an elevated perspective view of an embodiment of a lock controller used in the novel vehicle security system shown in FIG. 5;

FIG. 7 shows a cross-sectional view of an embodiment of a lock controller used in the novel vehicle security system shown in FIG. 5;

FIG. 8 shows an elevated perspective view of an alternate embodiment of a lock controller used in the novel vehicle security system shown in FIG. 5;

FIG. 9 shows a planar perspective view of an alternate embodiment of a lock controller used in the novel vehicle security system shown in FIG. 5;

FIG. 10 shows a planar cross-sectional view of an alternate embodiment of a lock controller used in the novel vehicle security system shown in FIG. 5 coupled to a vehicle;

FIG. 11 shows an elevated perspective view of an alternate embodiment of a lock controller used in the novel vehicle security system shown in FIG. 5;

FIG. 12 shows a planar perspective view of an alternate embodiment of a lock controller used in the novel vehicle security system shown in FIG. 5;

FIG. 13 shows a planar partial cross-sectional view of an embodiment of a novel vehicle security system being activated to lock the vehicle;

FIG. 14 shows a planar partial cross-sectional view of an embodiment of a novel vehicle security system being activated to unlock the engine compartment of the vehicle while the passenger compartment remains secured;

FIG. 15 shows a planar partial cross-sectional view of an embodiment of a novel vehicle security system being activated to unlock the passenger compartment the vehicle while the engine compartment remains secured;

FIG. 16 shows a planar partial cross-sectional view of an embodiment of a novel vehicle security system being activated to unlock the passenger compartment and engine compartment of the vehicle;

FIG. 17 shows an elevated perspective view of an embodiment of the auxiliary latch device body shown in FIGS. 13-16;

FIG. 18 shows a planar perspective view of an embodiment of the auxiliary latch device body shown in FIGS. 13-16;

FIG. 19 shows an elevated perspective view of an embodiment of a rooftop compartment configured to be affixed to a vehicle, the rooftop compartment having an embodiment of the novel vehicle security system include therewith;

FIG. 20 shows an elevated perspective view of an embodiment of a ski rack configured to be affixed to a vehicle, the ski rack having an embodiment of the novel vehicle security system include therewith;

FIG. 21 shows an elevated perspective view of an embodiment of utility toolboxes affixed to a vehicle, the tool boxes having an embodiment of the novel vehicle security system include therewith;

FIG. 22 shows an elevated perspective view of an embodiment of interior compartment for use in a vehicle, the interior compartment having an embodiment of the novel vehicle security system include therewith; and

FIG. 23 shows a schematic diagram of an alternate embodiment of a novel vehicle security system.

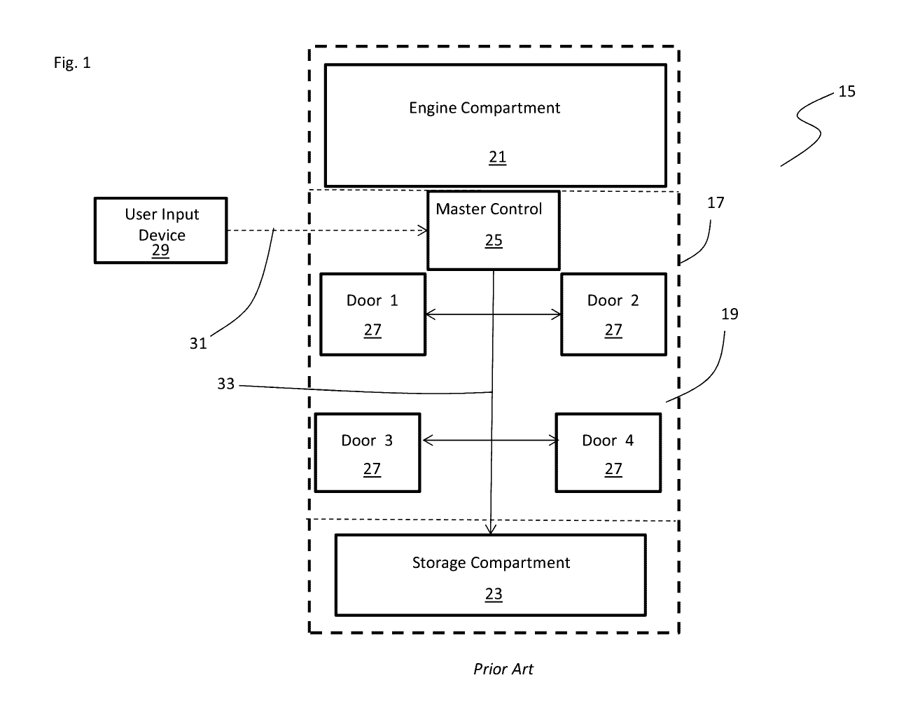

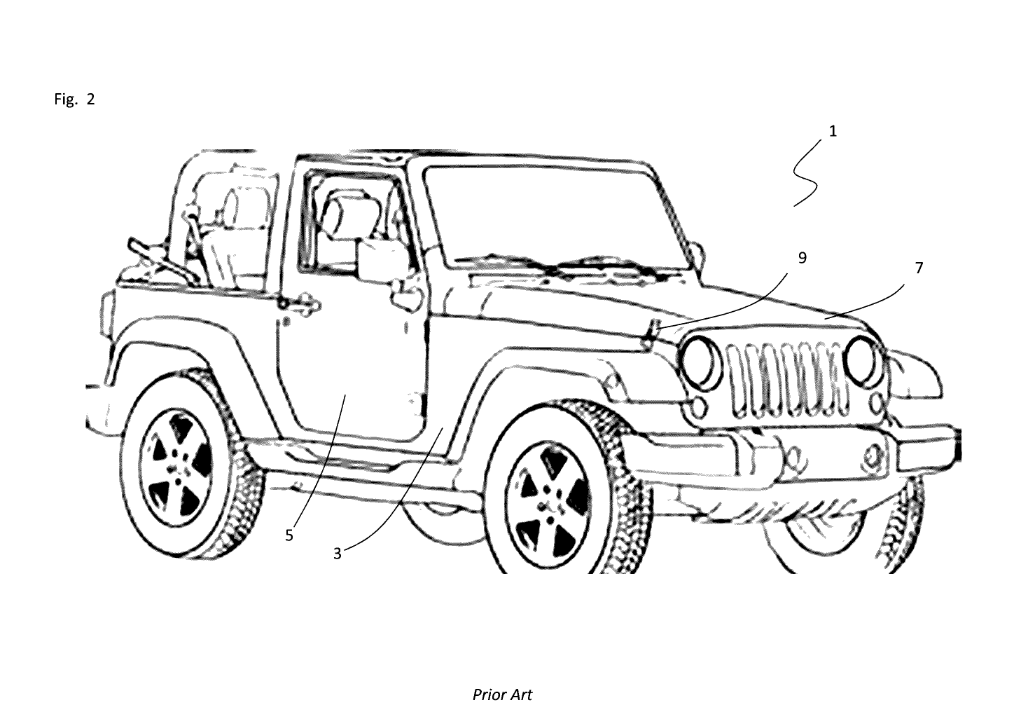

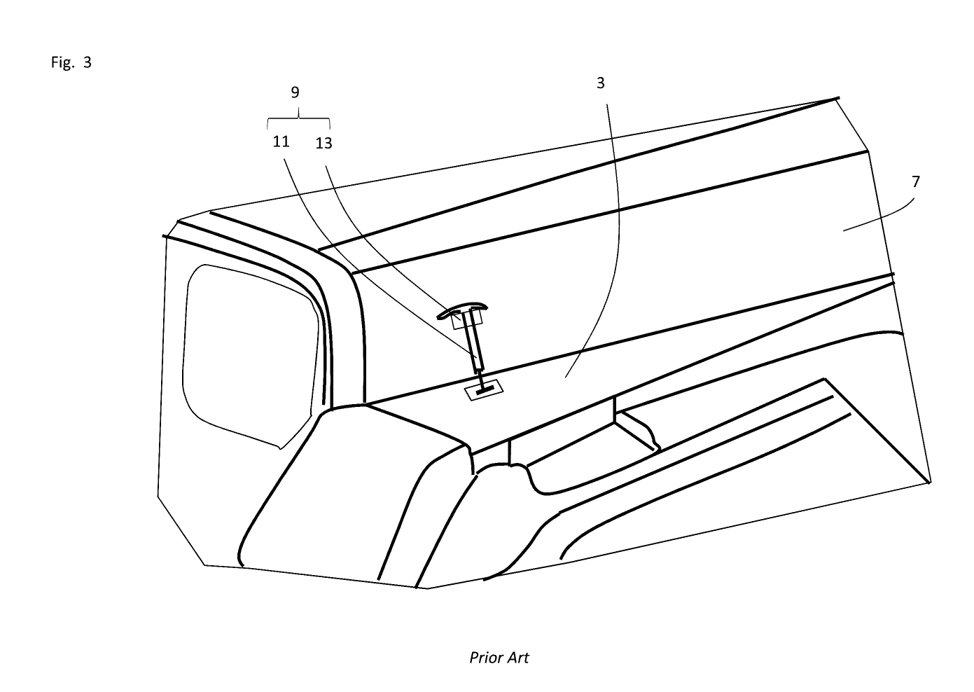

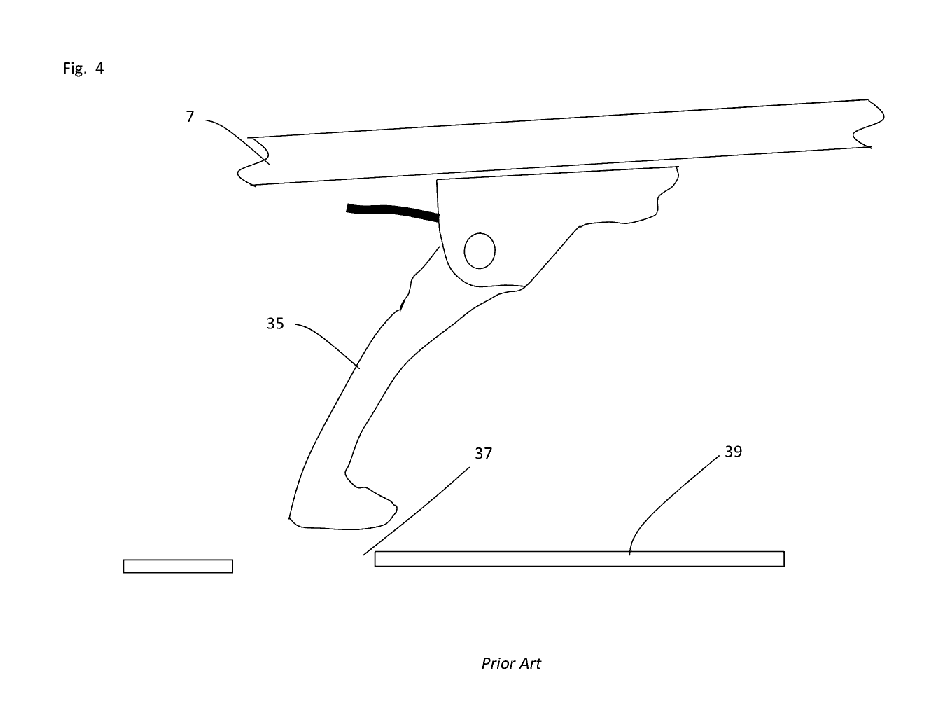

### DETAILED DESCRIPTION

The present application is directed to a vehicle security system which is capable of selectively locking and unlocking various compartments. In one embodiment, the vehicle security system which is capable of selectively locking and unlocking at least one internal compartment of a vehicle. For example, in one embodiment, the vehicle security system disclosed herein is configured to selectively restrict and/or permit access to the engine compartment of a Wrangler, similar SUV, or other vehicle. In another embodiment, the vehicle security system which is capable of selectively locking and unlocking at least one external compartment of a vehicle. For example, the vehicle security system disclosed herein may be configured to selectively permit and/or restrict access to one or more external boxes, tire carriers, tool boxes, ski carriers, bicycle racks, and the like. Optionally, the vehicle security system which is capable of selectively locking and unlocking at least one internal and/or external compartment of a vehicle.

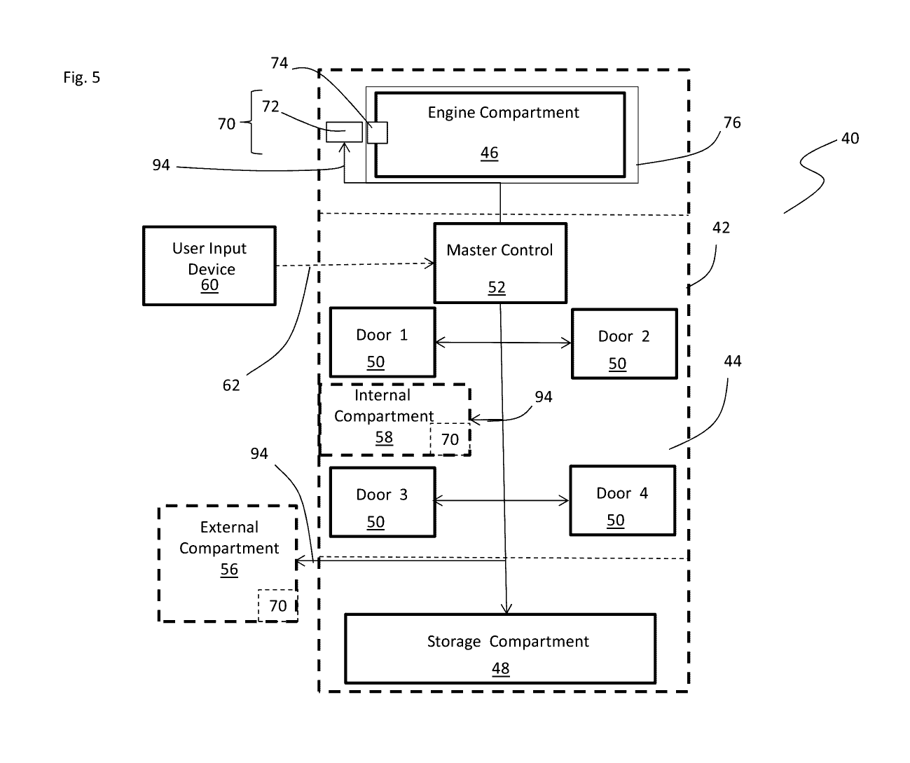

FIG. 5 shows a schematic diagram of an embodiment of the control system for a vehicle security system. As shown, the vehicle 40 includes a body 42 defining at least one passage compartment 44 and at least one engine compartment 46. Further, the vehicle 40 may include one or more storage compartments 48. For example, in one embodiment, the storage compartment 48 may comprise a trunk. In another embodiment, the storage compartment 48 may comprise a glove box.

Referring again to FIG. 5, the passenger compartment 44 further includes at least one door 50 permitting access to the passenger compartment 44. In addition, the vehicle 40 includes at least one master controller or computer 52. In one embodiment, the master controller 52 is configured to control various subsystems of the vehicle 40. For example, in one embodiment, the master controller 52 is configured to regulate operation of at least one of the ignition system, fuel system, internal security system, door locks, and the like. For example, the master controller 52 may be configured to selectively lock/unlock the doors 50.

Optionally, the vehicle 40 may include at least one external compartment 56, internal compartment 58, and/or both. Exemplary external compartments include, without limitations, tool boxes, ski carriers, bike racks, rack systems, tire carriers, fuel tanks, bed covers, roof boxes, and the like. Exemplary internal compartments include, without limitations, gun racks, audio equipment enclosures, glove boxes, storage boxes, and the like.

As shown in FIG. 5, the vehicle 40 may include at least one lock system 70. As shown, the lock system 70 may be positioned in various locations in or about the vehicle 40. For example, a security system 70 may be positioned within the engine compartment 46 and configured to selectively permit or restrict access to the engine compartment 46. In one embodiment, the security system 70 may be configured to selectively permit and/or restrict access to the engine compartment 46 of the vehicle 40 independent of the master controller 52. In an alternate embodiment, the security system 70 may be configured to selectively permit and/or restrict access to the engine compartment 46 of the vehicle 40 via the master controller 52. Optionally, as shown in FIG. 5, the security system 70 may also be positioned within at least one external compartment, internal compartment, or both, if present.

Referring again to FIG. 5, the security system 70 positioned within the engine compartment 46 includes at least one lock control body 72 and at least one lock member 74. In the illustrated embodiment the lock control body 72 may be positioned on the body 42 of the vehicle 40 while the lock member 74 may be positioned on the hood 76 selectively enclosing the engine compartment 46. Optionally, one or more security systems 70 may be positioned within or otherwise coupled to one or more external compartments. Exemplary external compartments 56 include, without limitations, ski racks, tool boxes, utility boxes, tire racks, fuel sources, roof racks, lift systems, ladder racks, towing hitches, sheet material carriers, pipe holders, pipe threaders, generators, pumps, and the like. Internal compartments 58 include, without limitations, boxes, enclosures, racks, lift systems and devices, equipment slides, and the like.

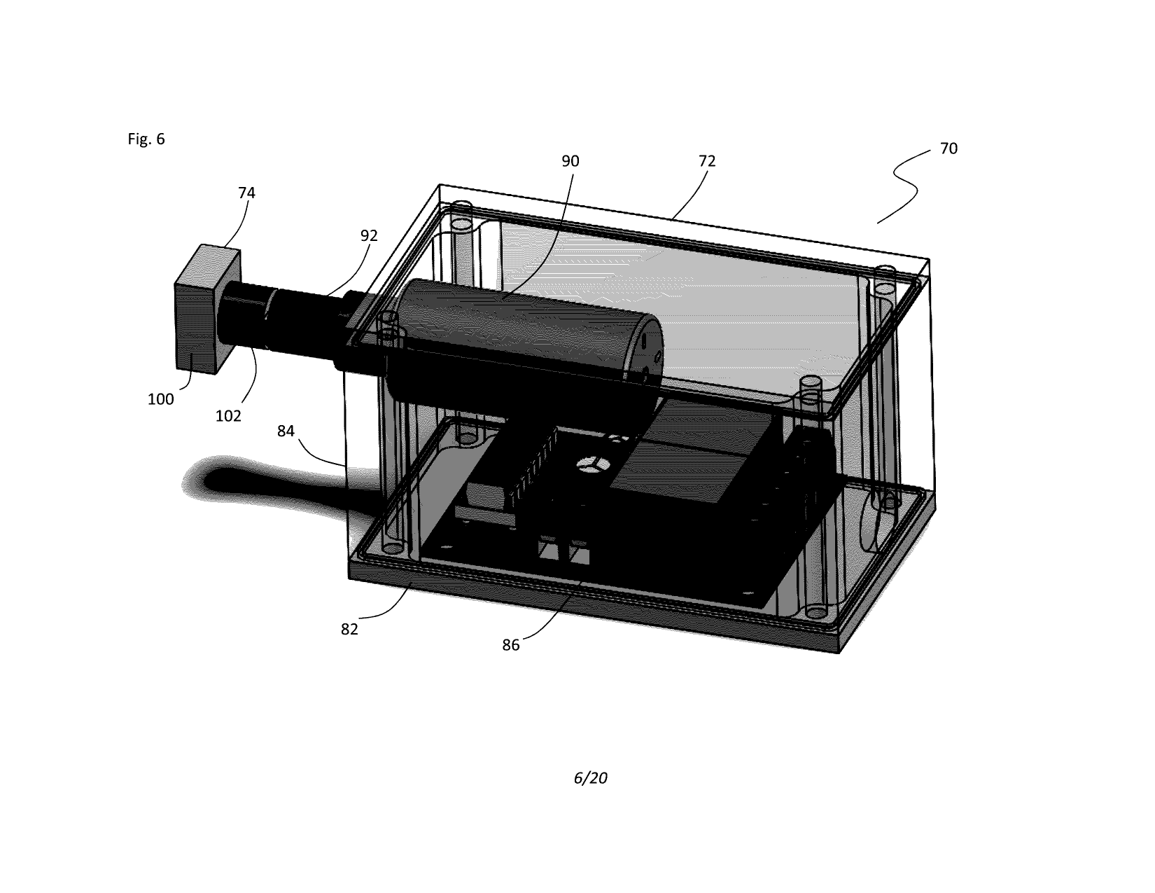

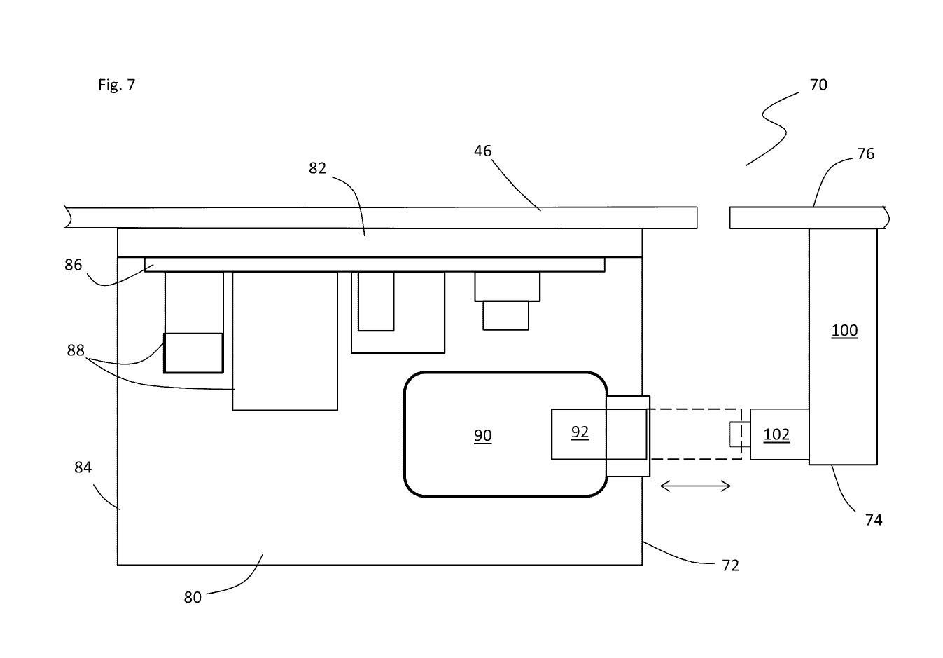

FIGS. 6 and 7 show various views of an embodiment of a security system 70 as shown in FIG. 5. As shown, the security system 70 includes at one lock controller 72 and at least one lock member 74. Those skilled in the art will appreciate that any number of lock controllers 72 may be used with any number of the lock members 74. Further, the lock controller 72 and lock member 74 may be sized and configured to be coupled to or otherwise positioned in various locations within and/or on the vehicle 40, the external compartment 56, and/or internal compartment 58 of the vehicle 40 (See FIG. 5).

Referring again to FIGS. 6 and 7, in one embodiment the lock controller 72 includes at least one controller body 80 formed from at least one least one base member 82 having at least one housing 84 coupled thereto or positioned proximate thereto. At least one control board and/or processor board 86 having one or more components and/or processors 88 thereon or in communication therewith may be positioned within the controller body 80. Exemplary components include, without limitations, microprocessors, ASICS, semiconductor devices, sensors, transmitters, memory devices, indicators, capacitors, inductors, resistors, diodes, power sources, and the like. Further, one or more actuators 90 may be positioned within the controller body 80 in communication with at least one of the control board 86 and component 88. In one embodiment, the actuator 90 comprises a mechanical actuator. In an alternate embodiment, the actuator 90 comprises a piezo-actuator. In another embodiment, the actuator 90 comprises a solenoid. Optionally, the actuator 90 may comprise a magnetic, acoustic, or similar actuator.

Referring again to FIGS. 6 and 7, at least one lock shaft or extension 92 is included with the controller body 80. In one embodiment, the lock shaft 92 is in movable communication with the actuator 90. For example, the lock shaft 92 may be configured to selectively extend from and/or retract to the controller body 80 via the actuator 90. In another embodiment, the lock shaft 92 may be configured to be rotatable about the longitudinal axis of the lock shaft 92. Further, the lock shaft 92 may be configured to engage and be retained by the lock member body 100. More specifically, the lock shaft 92 may be configured to selectively engage and be retained by the lock shaft receiver 102 of the lock member body 100 of the lock member 74. In the illustrated embodiment, the lock controller 72 may be positioned in the engine compartment 46 while the lock member 74 may be positioned on the hood 76 proximate to the lock controller 72. In the alternate embodiment, the lock controller 72 may be positioned on the hood 76 while the lock member 74 may be positioned in the engine compartment 46 proximate to the lock controller 72.

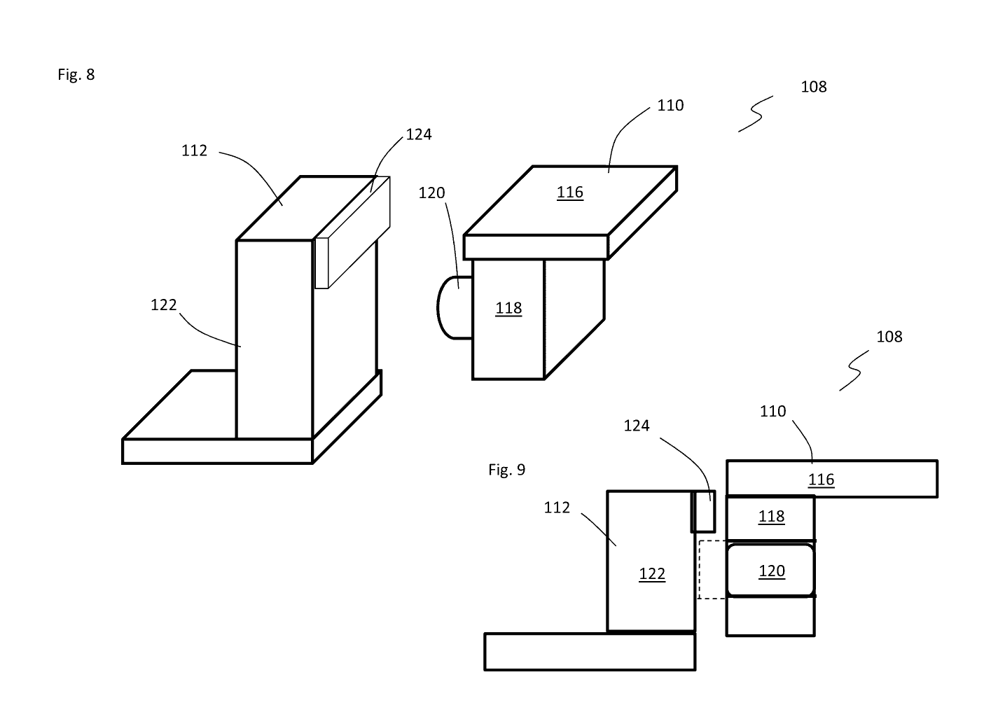

FIGS. 8 and 9 show another embodiment of the lock mechanism used in the security system shown in FIG. 5. As shown, the lock mechanism 108 of the security system utilizes at least one least lock controller 110 and at least one lock member 112. As shown, the lock controller 110 includes at least one base member 116 having at least one housing 118 coupled thereto or positioned proximate to the base member 116. Like the previous embodiment shown in FIGS. 5-7, the base member 116 and housing 118 shown in FIGS. 7 and 8 may be configured to enclose various components, actuator, receivers, circuit boards, power sources, sensors, and the like therein. As such, the lock shaft or extendable body 120 of the lock controller 110 may be configured to extend from and retract into the lock controller body 114 via at least one actuator (not shown) positioned within or proximate to the lock controller body 114.

Referring again to FIGS. 8 and 9, the lock member 112 may include at least one lock member body 122 having at least one lock fixture or lock shaft engaging body 124 formed thereon or positioned proximate thereto. During use, the lock controller 110 may be positioned within the engine compartment 46 of the vehicle 40 while the lock member 112 may be positioned on the hood 76 (See FIG. 5). The lock shaft 120 may be retracted into the lock controller body 114 of the lock controller 110, thereby permitting the user to gain access to the engine compartment 46 of the vehicle 40. Thereafter, the user may selectively actuate the user input device 60 to generate a user control signal 62. As a result, at least one actuator 90 (See FIGS. 5 and 6) positioned within the lock controller 110 selectively extends the lock shaft 120 from the lock controller body 114 which engages or is retained by the lock fixture 124 of the lock member 112, thereby preventing access to the engine compartment 46.

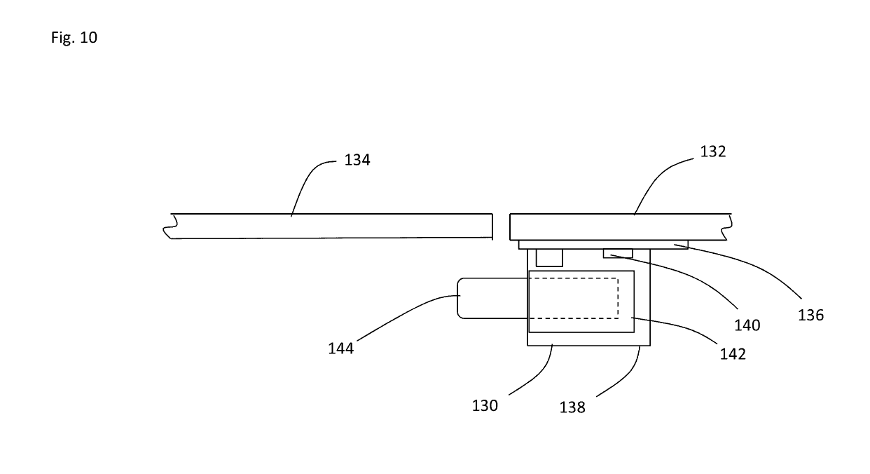

FIG. 10 shows an alternate embodiment of a security system for a vehicle or a compartment coupled to or in positioned within a vehicle. In contrast to the embodiments shown in FIGS. 5-9, the security system shown in FIG. 10 includes at least one lock controller 130 positioned on the hood 132 of the vehicle. Optionally, the lock controller 130 may be positioned on the vehicle body 134 proximate to the hood 132. In another embodiment, lock controller 130 may be positioned on or within an external compartment, internal compartment, rack system, or the like.

Referring again to FIG. 10, the lock controller 130 may include a base member 136 having at least one housing 138 coupled thereto or positioned proximate therewith. At least one component 140 may be positioned within the housing 138. Exemplary components include, without limitations, sensors, actuators, semiconductor devices, power sources, and the like. As shown, the lock controller 130 may include one or more actuators 142 configured to selectively move the lock member 144 from a retracted positioned within the housing 138 to an extended position configured to engage the vehicle body 134, thereby preventing the hood 132 from being vertically displaced from the vehicle body 134 and restricting the opening of the hood 132 of the vehicle.

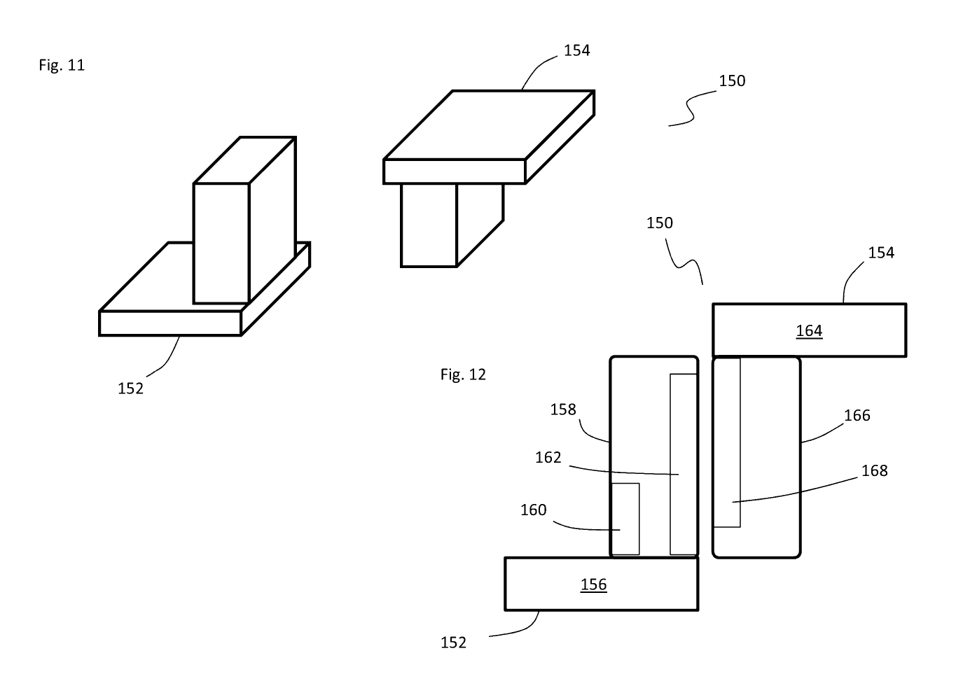

FIGS. 11 and 12 show an alternate embodiment of the lock mechanism of a security system described above. As shown, the security system 150 includes at least one lock controller 152 and at least one lock member 154. Those skilled in the art will appreciate that, optionally, the lock controller 152 and lock member 154 may comprise the identical or differing designs. As shown, the lock controller 152 may include at least one base plate 156 having at least one housing 158 coupled thereto or positioned proximate thereto. The housing 158 may include one or more components 160 therein. Exemplary components include, without limitations, sensors, actuators, semiconductor devices, power sources, actuators, and the like. Further, one or more magnets or electro-magnetic devices configured to selectively generate a magnetic field may be positioned within the housing 158. The housing 158 may include one or more magnetically-reactive devices or 162 therein.

Referring again to FIGS. 11 and 12, the lock member 154 may similarly include at least one base plate 164 having at least one housing 166 positioned thereon or positioned proximate thereto. The housing 166 may include one or more magnetically-reactive devices 168 therein. For example, one or more steel plates may be positioned within the housing 166. Optionally, the magnetically-reactive device 168 may comprise a magnet. During use, the magnetically-reactive devices 162, 168 may be configured to selectively apply a magnetic force to each other thereby securely positioning the lock controller 152 proximate to the lock member 154. Optionally, one or more components (not shown) may also be positioned within the housing 166. For example, various components enabling the magnetically-reactive device 168 to act as an electro-magnet may be positioned within the housing 166. As such, the lock device 150 may be configured to selectively permit or restrict access to the engine compartment 46 (See FIG. 5).

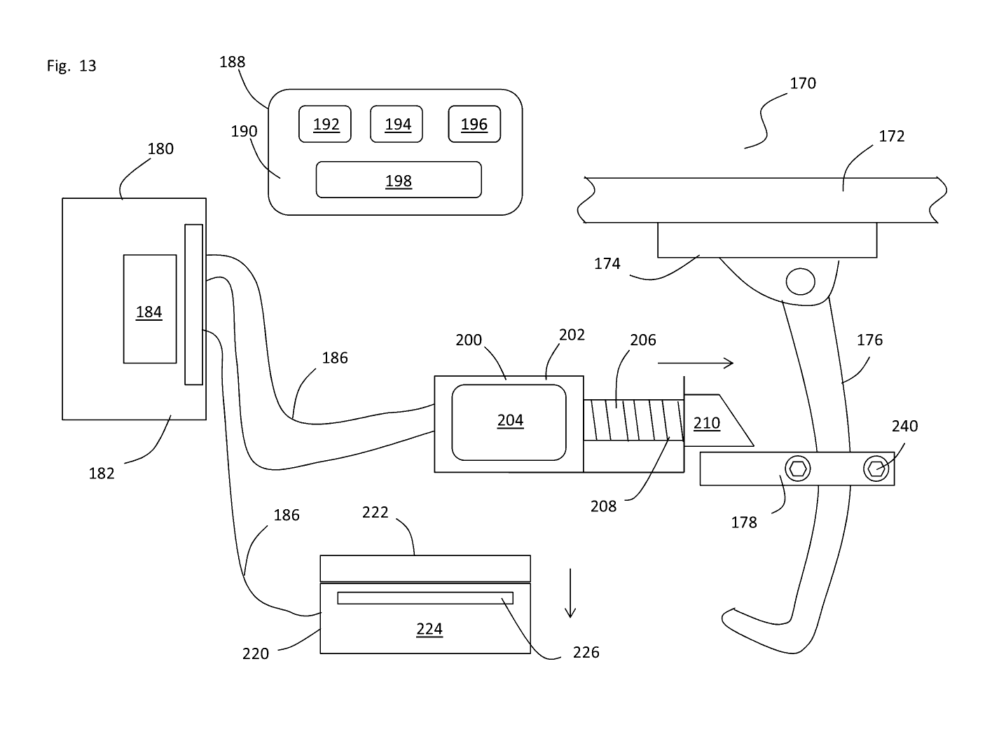

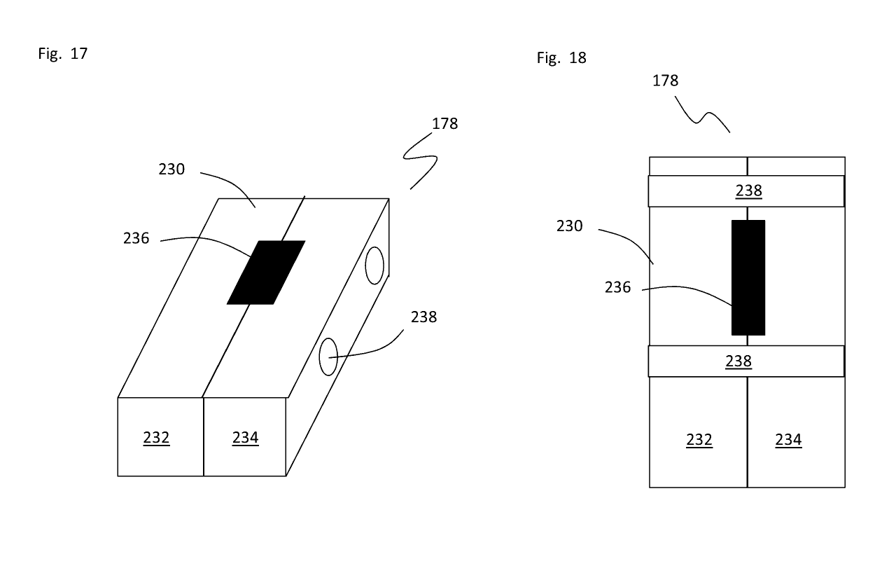

FIGS. 13-18 describe one exemplary embodiment of a vehicle security system for use on a vehicle incorporating the various component described in FIGS. 5-7 above. As shown, the vehicle hood 172 includes at least one safety latch system 174 coupled thereto. Those skilled in the art will appreciate that most if not all vehicle sold today include at least one hood safety latch system 174 positioned on or otherwise coupled to the hood 172 of the vehicle. The safety latch system 174 typically includes at least one safety latch body 176 configured to selectively engage at least a portion of the vehicle.

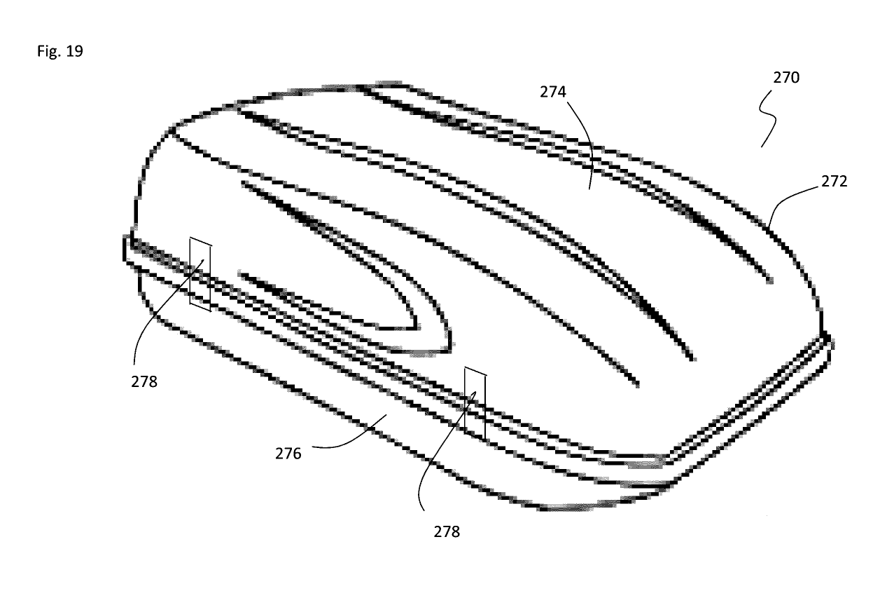

Referring again to FIGS. 13-18, the vehicle security system 170 includes at least one auxiliary latch device 178 positioned on or coupled to at least a portion of the safety latch system 174. In the illustrated embodiment, the auxiliary latch device 178 is position on the safety latch body 176, although those skilled in the art will appreciate that the auxiliary latch device 178 may be positioned anywhere on the safety latch system 174. As shown in FIG. 18, the auxiliary latch device 178 includes an auxiliary latch device body 230 formed by a first body member 232 and at least a second body member 234. The first and second body members 232, 234 cooperatively form a safety latch device receiver 236 formed therein. As shown, in one embodiment the first and second body members 232, 234 may be coupled to one another using one or more fasteners 240 (See FIGS. 13-16) positioned within one or more fastener receivers 238 formed in the first and second body members 232, 234. As such, the auxiliary latch device 178 may be coupled to the safety latch body 176 using a compressive or clamping force. As such, the auxiliary body device 178 may be detachably and adjustably coupled to the safety latch body 176. Optionally, the auxiliary latch device 178 may be detachably or non-detachably coupled to the safety latch body 176. As such, the auxiliary latch device 178 may be coupled to the safety latch body 176 using welds, bolts, screws, adhesives, and the like.

Referring again to FIGS. 13-16, at least one security system control device or lock controller 180 may be coupled to or positioned within the vehicle. For example, in one embodiment the security system control device 180 may be in electrical communication with the battery of the vehicle. Optionally, the security system control device 180 may be positioned within the passenger compartment of the vehicle. In another embodiment, the security system control device 180 is positioned within the engine compartment of the vehicle. As shown, the security system control device 180 includes at least one control device body 182 housing one or more components 184 therein. Exemplary components include, without limitations, circuit boards, integrated circuits, communication devices, power sources, transducers, transformers, fuses, and the like.

As shown in FIGS. 13-16, the security system 170 may include one or more remote control devices or user interface devices 188 in communication with the security system control device 180. In the illustrated embodiment, remote control device 188 includes a remote body 190 having one or more actuators or buttons thereon. The remote body 190 may be configured to house various components therein, including, without limitations, circuits boards, transponders, wireless communication devices, batteries, power sources, and the like. In the illustrated embodiment, the remote body 190 includes at least one hood lock button 192, at least one auxiliary lock button 194, at least one security system lock button 198, and at least one security system unlock button 198. Those skilled in the art will appreciate that any number of buttons may be includes on the remote control devices or user interface devices 188. Further, those skilled in the art will appreciate that security system 170 described herein may be configured to have the functions performed by the remote control device 188 performed by existing remote control devices associated with the user's vehicle. As such, a single remote control device may be configured to arm/disarm the various components of the vehicle security system 170 are well as any components of the target vehicle, including, for example, remote starters, door lock/unlock systems, and the like. Optionally, in another embodiment, the various functions performed by the remote control device 188 may be performed by a smartphone or external controller having an associated computer application thereon.

As shown in FIGS. 13-16, the security system control device 180 in communication with the remote control device 188 and at least one hood lock device 200. In the illustrated embodiment, the security system control device 180 is in communication with the hood lock device 200 via at least one conduit 186. In another embodiment, the security system control device 180 is in wireless communication with the hood lock device 200. As shown the hood lock device 200 includes a body 202 having at least one component 204 therein. In one embodiment, the hood lock device 200 and the associated components 204 are explained in greater detail above as outline in paragraph [0012]-[0014] and shown in FIGS. 6 and 7. Exemplary components including, transformers, transducers, batteries, power sources, diodes, capacitors, resistors, actuators, piezo-actuators, electro-actuators, magnetic devices, control boards, processors, memory devices, ASICS, integrated circuits, and the like. Further, the hood lock device 200 includes at least one lock shaft 208 having one or more biasing members 206 thereon or positioned proximate thereto. In one embodiment, the biasing member 206 is configured to bias the lock shaft 208 to an extended position. Further, the lock shaft 208 may include one or more engaging bodies 210 thereon, the engaging bodies 210 configured to engage the auxiliary latch device 178 positioned on the safety latch body 176 thereby selectively restricting movement of the hood 172.

Optionally, the vehicle security system 170 may include any number hood lock devices 200 and any number of auxiliary lock bodies 220. As shown in FIGS. 13-16, in one embodiment the auxiliary lock device 220 includes at least one plate member 222 and at least one auxiliary lock body 224. In one embodiment, the auxiliary lock body 224 includes one or more components 226 therein. For example, in one embodiment at least one component 226 comprises an electro-magnetic device configured to selectively apply a magnetic force to permit or prevent the plate member 222 from being coupled to or detached from the auxiliary lock device 224. As such, the auxiliary lock device 224 may be in communication with the security system control device 180. In one embodiment, one or more hood lock devices 200 and/or auxiliary lock devices 220 may be used to secure a variety of internal compartments, external compartments, tire carriers, rooftop boxes, bike carriers, tool boxes, and the like.

As shown in FIG. 13, during use the user may lock the vehicle security system 170 by actuating the system lock button 196 located on the remote control device 190. As a result, a control signal is sent from the remote control device 190 to the security system control device 180. Thereafter, the control device 180 sends a lock signal to both the hood lock device 200 and to at least one auxiliary lock device 220. As a result, the components 204 of the hood lock device 220 and the biasing device 206 apply a biasing force to the lock shaft 208 thereby extending the lock shaft 208 from the hood lock device 200 and engaging the auxiliary latch device 178 coupled to the safety latch body 176. As a result, the hood 172 is secured. In addition, a control signal is sent from the security system control device 180 to the auxiliary lock device 220 which applies power/current to the component 226 which results in a magnetic force being applied to the plate member 222 thereby magnetically coupling the plate member 222 to the auxiliary lock body 224. As a result, both the hood lock device 200 and auxiliary lock device 220 are in a locked state.

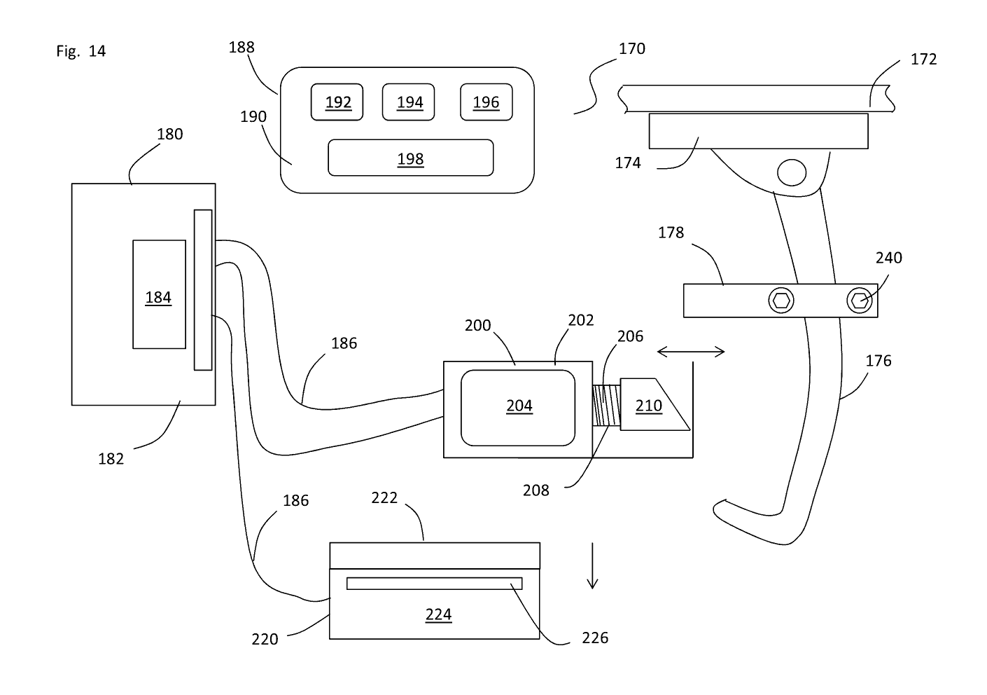

As shown in FIG. 14, the user may selectively unlock the hood lock device 200 of the vehicle security system 170 by actuating the hood lock button 192 located on the remote control device 190. To open the hood 170, at least one control signal is sent from the security system control device 180 which instructs the components 204 within the hood lock body 202 to retract the lock shaft 208 into or proximate to hood lock body 202, thereby permitting the safety latch body 176 to freely move. In contrast, the user may selectively lock the hood lock device 200 of the vehicle security system 170 by actuating the hood lock button 192 located on the remote control device 190. As a result, the security system control device 180 sends a lock signal to the hood lock device 200. As a result, the components 204 of the hood lock device 220 and the biasing device 206 may selectively extend the lock shaft 208 distally from the hood lock body 202, thereby resulting in the engaging body 210 restricting vertical movement of the safety latch body 176, thereby securing the hood 170. Further, the state (locked/unlocked) of the auxiliary lock device 220 remains unchanged.

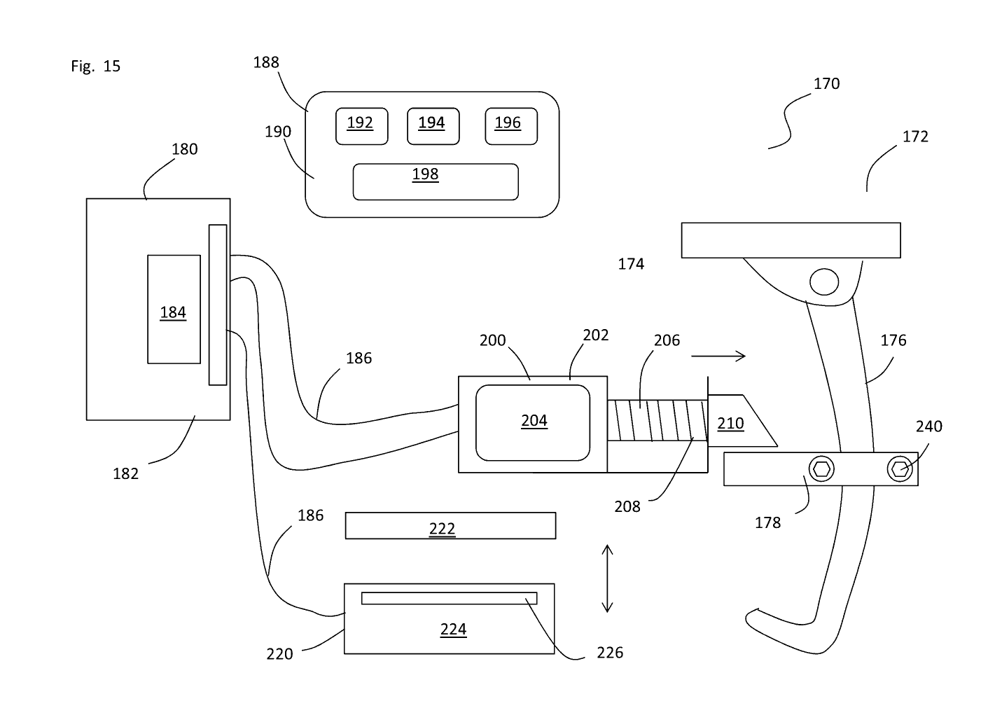

As shown in FIG. 15, the user may selectively unlock the auxiliary lock device 220 of the vehicle security system 170 by actuating the auxiliary lock button 194 located on the remote control device 190. To open the a compartment, box, rack, or similar device incorporating the auxiliary lock device 220, at least one control signal is sent from the security system control device 180 which instructs the components 226 within the auxiliary lock body 220 to discontinue applying a magnetic field generated by at least one electro-magnetic device located within the auxiliary lock body 224, thereby permitting the plate member 222 to be decoupled from the auxiliary lock body 224. In contrast, the user may selectively lock the auxiliary lock device 220 of the vehicle security system 170 by actuating the auxiliary lock button 194 located on the remote control device 190. As a result, the security system control device 180 sends a lock signal to the auxiliary lock device 220. As a result, the components 226 of the auxiliary lock body 224 selectively generates a magnetic field which is applied to the plate member 222, thereby resulting in the plate member 222 be magnetically coupled to the auxiliary lock body 224. Further, the state (locked/unlocked) of the hood lock device 200 remains unchanged.

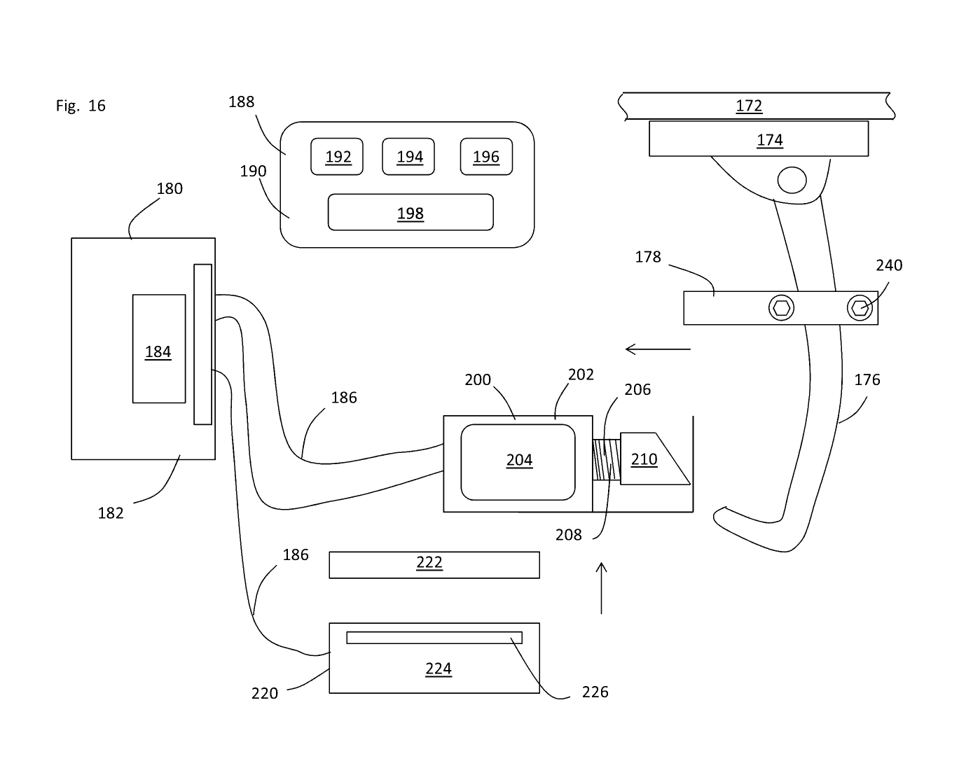

As shown in FIG. 16, during use the user may unlock the vehicle security system 170 by actuating the system lock button 198 located on the remote control device 190. As a result, a control signal is sent from the remote control device 190 to the security system control device 180. Thereafter, the control device 180 sends an unlock signal to both the hood lock device 200 and to at least one auxiliary lock device 220. As a result, the components 204 of the hood lock device 220 apply a retracting force to the lock shaft 208 thereby withdrawing the lock shaft 208 to the hood lock device 200 and disengaging the auxiliary latch device 178 coupled to the safety latch body 176. As a result, the hood 172 is unsecured. In addition, a control signal is sent from the security system control device 180 to the auxiliary lock device 220 which discontinues the application of current to the component 226 positioned within the auxiliary device body 224 which terminates the magnetic force being applied to the plate member 222 thereby permitting the plate member 222 to be decoupled from the auxiliary lock body 224. As a result, both the hood lock device 200 and auxiliary lock device 220 are in an unlocked state.

As shown in FIG. 15, the user may selectively unlock the auxiliary lock device 220 of the vehicle security system 170 by actuating the auxiliary lock button 194 located on the remote control device 190. To open the auxiliary lock device 220, at least one control signal is sent from the security system control device 180 which instructs the components 226 within the auxiliary lock body 224 to restrict the flow of current to at least one magnetic component within the auxiliary lock body 224, thereby permitting the plate member 222 to be detachable from the auxiliary lock body 224. In contrast, the user may selectively lock hood lock device 200 of the vehicle security system 170 by actuating the hood lock button 192 located on the remote control device 190. As a result, the remote control device sends a lock signal to the hood lock device 200. As a result, the components 204 of the hood lock device 220 and the biasing device 206 may selectively extend the lock shaft 208 distally from the hood lock body 202, thereby resulting in the engaging body 210 restricting vertical movement of the safety latch body 176, thereby securing the hood 170. Further, the state (locked/unlocked) of the auxiliary lock device 220 remains unchanged.

As stated above, in one embodiment, the security system disclosed herein is well-suited for use on various vehicles, automobiles, motorcycles, and the like. In another embodiment, the security system disclosed herein well-suited for use with Jeep Wranglers, Range Rovers, Land Rovers, SUVs, and other vehicles utilizing an external hood latch, and internal hood release system, or both. Further, the security system disclosed herein may be incorporated into or otherwise attached to various other devices. For example, FIG. 19 shows an embodiment of an external compartment or storage box commonly secured to the roof rack of a vehicle. As shown, the storage box 270 include a body 272 formed from a first body member 274 and at least a second body member 276. As shown, at least one security system 278 as described above may be coupled to the first and second body members 274, 276, thereby permitting the user to selectively permit or restrict access to the storage box 270.

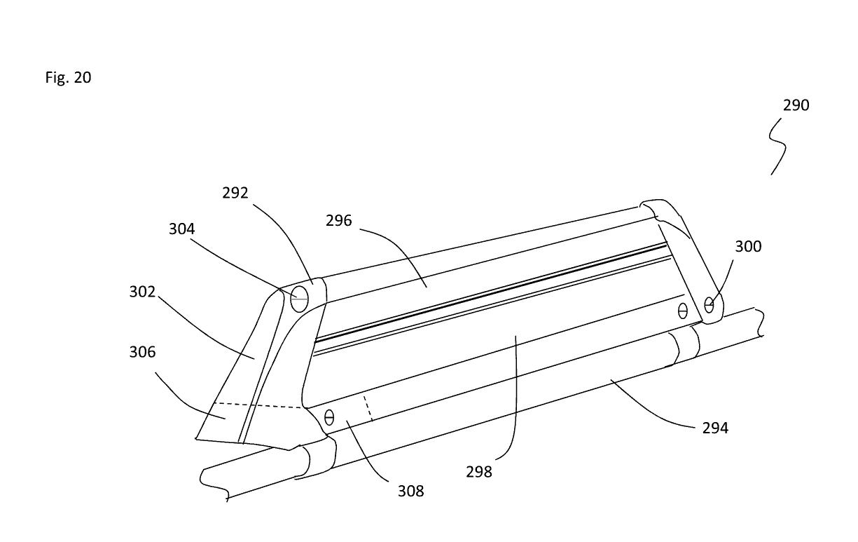

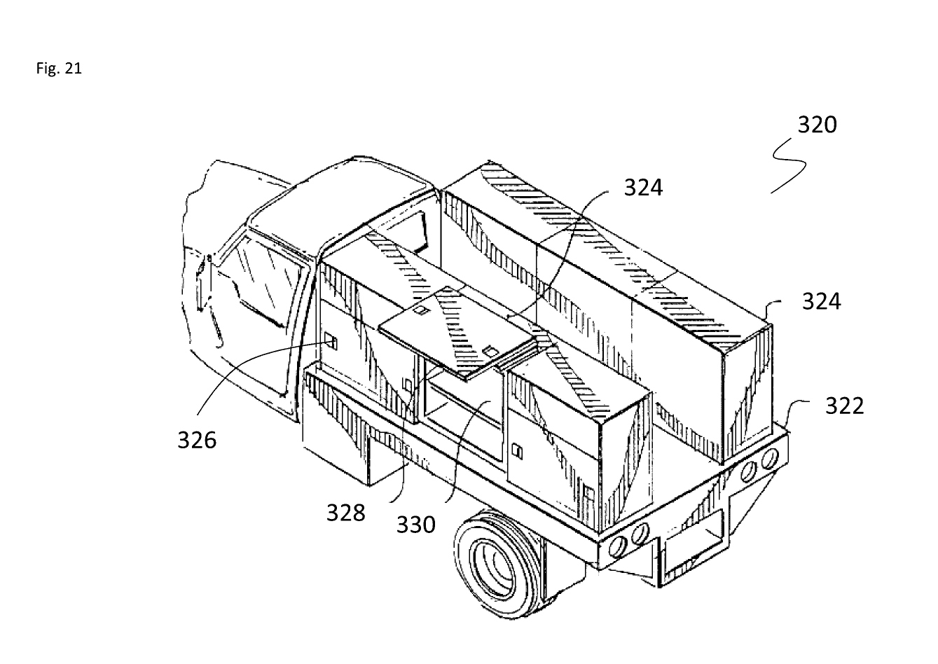

FIG. 20 shows an embodiment of a ski/snowboard rack or carrier which includes the security system disclosed in the present application. As shown, the ski rack 290 includes at least one rack body 292 coupled to a roof rack system 294. Further, the rack body is formed by a first rack component 296 and at least a second rack component 298. The first rack component 296 may be configured to be movable in relation the second rack component 298 via a pivot pin or body 300. Further, at least one movable latch feature 302 may be used to selectively secure the position the first rack component 296 proximate to the second rack component 298. The movable latch feature may also include at least one latch pivot pin or device 304. In addition, at least one lock controller 306 may be positioned on the latch feature 302 while at least one lock member 308 may be positioned on at least one of the first rack component 296, second rack component 298, or both. Those skilled in the art will appreciate that lock controller 306 and lock member 308 may be positioned anywhere on the ski rack 290.

FIG. 21 shows an embodiment of vehicle having multiple tool boxes or storage areas coupled thereto. As shown, the vehicle 320 includes a truck bed 322 having multiple tool boxes 324 secured to the truck bed 322. As shown, at least one tool box 324 includes one or more security systems 326 described above coupled to at least one of the tool box door 328 and the receiving area 330 of the tool box 324. In the illustrated embodiment, the tool boxes 324 are secured to the bed 322 of a truck. Optionally, those skilled in the art will appreciate that at least one of the illustrated tool boxes 324 may be used with any variety of vehicles.

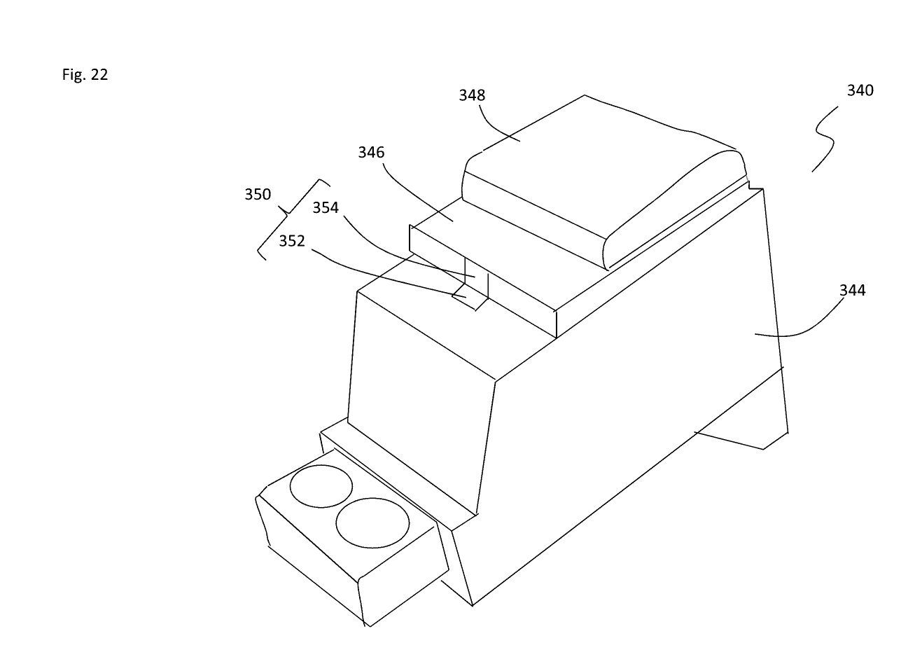

FIG. 22 shows an embodiment of a console device or internal storage compartment for use in a variety of vehicles. As shown, the console device 340 includes a console body 344 having at least one lid 346 coupled thereto. One or more pads or arm rests 348 may be positioned on at least one of the console body 344 or lid 346. Further, at least one security system 350 as described above may be included with or coupled to the console device 340. In the illustrated embodiment, at least one lock controller 352 may be positioned on the console body 344. Further, at least one lock member 354 may be positioned on the lid 346. Optionally, the lock controller 352 and/or lock member 354 may be positioned on various elements of the console device 340.

FIG. 5 shows an embodiment of a vehicle having an embodiment of the security system described in the present application included therein. In the embodiment described in FIG. 5, at least one user input device 60 selectively emits at least input signal 62 which is sent to the master control 52. Thereafter, the master control 52 sends at least one signal to at least one security system 70 positioned in or coupled to at least one of the engine compartment 46, external compartment 56, and/or internal compartment 58. In addition, the present security system may be configured to operate using the signal generated by the master control 46 configured to disarm/arm a pre-existing security system, automatic door locks, and the like. As such, the security system disclosed herein may be easily integrated into factory-installed or aftermarket security system.

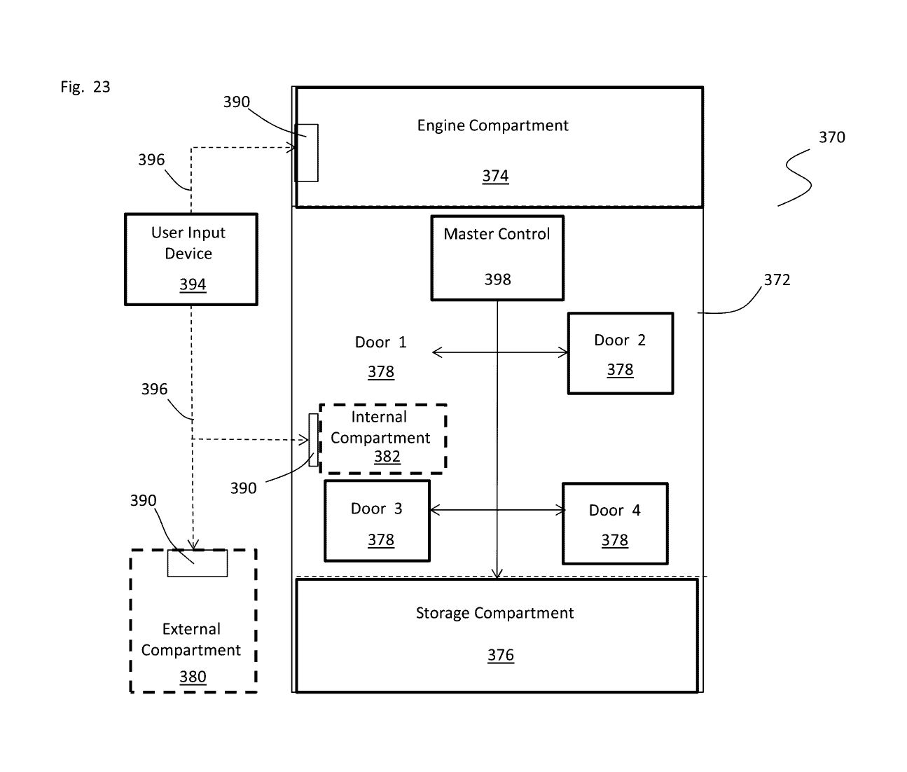

In contrast, FIG. 23 shows an alternate embodiment of vehicle having the security system described in the present application included herein. As shown, the vehicle 370 includes a passenger compartment 372 having an engine compartment 374 and at least one trunk or storage compartment 376. The passenger compartment 372 includes one or more doors 378 formed therein. Further, the vehicle 370 may include one or more external compartment 380, internal compartment 382, or both. As shown, at least one security system 390 described herein may be positioned within or coupled to at least one of the engine compartment 374, external compartment 380, and the internal compartment 382. As shown, the user input device 394 selectively generates at least one user input signal 396 when actuated by the user. In contrast to the embodiment shown in FIG. 5, the user input signal 396 is transmitted directly to at least one security system 390 positioned within at least one of the engine compartment 374, external compartment 380, and the internal compartment 382, thereby forgoing the master control 398.

The embodiments disclosed herein are illustrative of the principles of the invention. Other modifications may be employed which are within the scope of the invention. Accordingly, the devices disclosed in the present application are not limited to that precisely as shown and described herein.

What is claimed:

1. A vehicle security system configured to selectively secure a compartment of a vehicle, the vehicle security system comprising:
at least one user input device, the user input device configured to generate one or more input signals;
at least one lock control body positioned within a compartment of a vehicle and in communication with the user input device, the lock control body having at least one housing having at least one lock shaft configured to be selectively extendable from and retractable to the housing in response to the input signal from the user input device; and
at least one lock shaft receiver positioned on a door of the compartment proximate to the lock control body and configured to receive the lock shaft therein.

2. The vehicle security system of claim 1 wherein the compartment comprises an engine compartment.

3. The vehicle security system of claim 2 wherein the lock control body is positioned within the engine compartment and the lock shaft receiver is positioned on a hood enclosing the engine compartment.

4. The vehicle security system of claim 1 wherein the compartment is positioned external of the vehicle.

5. The vehicle security system of claim 1 wherein the compartment comprises at least one tool box.

6. The vehicle security system of claim 1 wherein the compartment comprises at least one ski rack.

7. The vehicle security system of claim 1 wherein the compartment is positioned within the vehicle.

8. The vehicle security system of claim 1 wherein the compartment comprises a console positioned within the vehicle.

9. The vehicle security system of claim 1 wherein the compartment comprises a lock box positioned within the vehicle.

10. The vehicle security system of claim 1 further comprising at least one control board having at least one component thereon, the component in communication with at least one actuator positioned within the housing and configured to selectively extend and retract the lock shaft in response to the input signal from the user input device.

11. The vehicle security system of claim 10 wherein the component is selected from the group consisting of microprocessors, ASICS, semiconductor devices, sensors, transmitters, memory devices, indicators, capacitors, inductors, resistors, and diodes.

12. The vehicle security system of claim 1 wherein the user input device comprises a key fob.

13. A vehicle security system configured to selectively secure an engine compartment of a vehicle, the vehicle security system comprising:
at least one user input device, the user input device configured to generate one or more input signals;
at least one lock control body positioned on a body of the vehicle and located within an engine compartment of a vehicle and in communication with the user input device, the lock control body having at least one housing having at least one lock shaft in communication with at least one actuator, the lock shaft configured to be selectively extendable from and retracted to the housing in response to the input signal from the user input device; and
at least one lock shaft receiver positioned on a hood of the vehicle enclosing the compartment proximate to the lock controller, the lock shaft receiver configured to receive the lock shaft therein.

14. The vehicle security system of claim 13 further comprising at least one control board having at least one component thereon, the component in communication with at least one actuator positioned within the housing and configured to selectively extend and retract the lock shaft in response to the input signal from the user input device.

15. The vehicle security system of claim 14 wherein the component is selected from the group consisting of microprocessors, ASICS, semiconductor devices, sensors, transmitters, memory devices, indicators, capacitors, inductors, resistors, and diodes.

16. The vehicle security system of claim 13 wherein the user input device comprises a key fob.

17. A vehicle security system configured to selectively secure an engine compartment of a vehicle, the vehicle security system comprising:
at least one user input device, the user input device configured to generate one or more input signals;
at least one auxiliary safety latch body coupled to a safety latch system positioned on a hood of a vehicle within an engine compartment of the vehicle; and
at least one lock control body positioned within the engine compartment and in communication with the user input device, the lock control body having at least one housing having at least one lock shaft in communication with at least one actuator, the lock shaft configured to be selectively extendable from housing and configured to engage the auxiliary safety latch body in response to the input signal from the user input device thereby preventing the hood from opening, and the lock shaft configured to be selectively retractable to the housing and configured to disengage the auxiliary safety latch body in response to the input signal from the user input device thereby permitting the hood to open.

18. The vehicle security system of claim 17 wherein the auxiliary safety latch device is detachably coupled to the safety latch system of the vehicle.

19. The vehicle security system of claim 17 wherein the component is selected from the group consisting of microprocessors, ASICS, semiconductor devices, sensors, transmitters, memory devices, indicators, capacitors, inductors, resistors, and diodes.

20. The vehicle security system of claim 17 further comprising:
at least one auxiliary lock body positioned on a portion of a compartment coupled to the vehicle, the auxiliary lock body having at least one selectively magnetically-reactive device therein, the magnetically-reactive device in communication with the user input device via the lock control body; and
at least one plate member positioned on a portion of the compartment coupled to the vehicle proximate to the magnetically-reactive device, wherein the plate member may be selectively movable is relation to the magnetically-reactive device in response to at least one signal from the user input device.

21. The vehicle security system of claim 20 wherein the auxiliary lock body and plate member are configured to selectively permit and restrict access to the compartment using a selectively operable magnetic field.
